(19) United States
(12) Patent Application Publication
(10) Pub. No.: US 2025/0282014 A1
(43) Pub. Date: Sep. 11, 2025

(54) ROTARY JOINT DEVICE, MOTOR, AND MACHINE TOOL

(71) Applicant: BROTHER KOGYO KABUSHIKI KAISHA, Nagoya (JP)

(72) Inventor: Kentaro SHINODA, Nagoya (JP)

(73) Assignee: BROTHER KOGYO KABUSHIKI KAISHA, Nagoya (JP)

(21) Appl. No.: 19/072,255

(22) Filed: Mar. 6, 2025

(30) Foreign Application Priority Data
Mar. 11, 2024 (JP) 2024-037360

(51) Int. Cl. B23Q 11/12; H02K 7/00

(52) U.S. Cl. CPC B23Q 11/12; H02K 7/003

(57) ABSTRACT

The rotary joint device includes: a rotary-side joint having a first hole through which liquid is to flow in an axial direction; a fixed-side joint configured to reciprocate in the axial direction of approaching and separating from the rotary-side joint, the fixed-side joint further having a second hole in the axial direction that communicates with the first hole in a state where the fixed-side joint is in contact with the rotary-side joint; an attachment being fixable to another member; a DLC (diamond-like carbon) film provided on an outer peripheral surface of the fixed-side joint; and an elastic member interposed liquid-tight between an inner peripheral surface of the attachment and the DLC film.

### REFERENCE TO RELATED APPLICATIONS

This application claims priority from Japanese Patent Application No. 2024-037360 filed on Mar. 11, 2024. The entire content of the priority application is incorporated herein by reference.

### BACKGROUND ART

Conventionally, for example, a machine tool may be provided with a rotary joint device. When the rotary joint device includes respective tubular rotary-side joint and fixed-side joint, the end face of one end of the rotary-side joint faces the end face of one end of the fixed-side joint. The other end of the rotary-side joint is connected to a tubular rotary shaft provided by, for instance, a motor. The attachment provided by the rotary joint device is fixed to a fixed member provided by the machine tool. The attachment has a through hole. The other end of the fixed-side joint is inserted into the through hole of the attachment. Coolant (liquid) is pumped by the pump of a coolant supply device installed outside the machine tool and flows through the through hole of the attachment. An elastic member is interposed liquid-tight (to prevent liquid leakage) between the inner peripheral surface of the through hole of the attachment and the outer peripheral surface of the fixed-side joint.

The rotary shaft of the motor rotates in the circumferential direction. The rotation of the rotary shaft is transmitted to the tool, and the tool processes the workpiece. The tool has a nozzle.

By the coolant flowing through the through hole of the attachment pushing the fixed-side joint, the fixed-side joint comes into contact with the rotary-side joint. The coolant flows through the through hole of the attachment, the through hole of the fixed-side joint, the through hole of the rotary-side joint, and the through hole of the rotary shaft in this order, and is ejected towards the workpiece from the nozzle provided by the tool.

As the rotary shaft rotates, the rotary-side joint rotates in the circumferential direction. If the supply of coolant to the through hole of the attachment stops while the motor is rotating, the fixed-side joint will be separated from the rotary-side joint due to the wind pressure created by the rotation of the rotary-side joint or because the biasing member of the rotary joint device pushes the fixed-side joint.

In a conventional rotary joint device, the fixed-side joint moves back and forth in the direction of approaching and separating from the rotary-side joint. Due to the reciprocating movement of the fixed-side joint, the elastic member slides relative to the outer peripheral surface of the fixed-side joint.

In such conventional rotary joint device, supply holes may be provided for supplying grease between the outer peripheral surface of the fixed-side joint (referred to as “fixed shaft” in the document) and the elastic member (referred to as “O-ring” in the document). With the intervention of grease, the reciprocating movement of the fixed-side joint is smooth.

However, if the contact of the fixed-side joint with the rotary-side joint is not smooth, the coolant might leak between the fixed-side joint and the rotary-side joint. If the separation of the fixed-side joint from the rotary-side joint is not smooth, the fixed-side joint and the rotary-side joint might wear unnecessarily.

### SUMMARY

Thus configured conventional rotary joint device is rather complicated to the extent that it requires grease supply holes.

An object of the present disclosure is to provide a rotary joint device, a motor, and a machine tool that can achieve both smooth reciprocating movement of the fixed-side joint and simplification of the structure.

The rotary joint device according to the present disclosure includes: a tubular rotary-side joint having a first hole through which liquid is to flow in an axial direction, the rotary-side joint being rotatable in a circumferential direction; a fixed-side joint having a tubular shape and an end face at one end facing an end face at one end of the rotary-side joint, the fixed-side joint being configured to reciprocate in the axial direction of approaching and separating from the rotary-side joint, the fixed-side joint further having a second hole in the axial direction that communicates with the first hole of the rotary-side joint in a state where the fixed-side joint is in contact with the rotary-side joint; an attachment having an inner peripheral surface, the attachment being fixable to another member, the inner peripheral surface defining a third hole through which the liquid is to flow and into which the other end of the fixed-side joint is inserted; a DLC (diamond-like carbon) film provided on an outer peripheral surface of the fixed-side joint; and an elastic member interposed liquid-tight between the inner peripheral surface of the attachment and the DLC film, the elastic member being slidable with respect to the DLC film when the fixed-side joint moves in the axial direction with respect to the rotary-side joint. The DLC film is provided in a contact area where the elastic member contacts on the outer peripheral surface.

In the rotary joint device according to the present disclosure, both the rotary-side joint and the fixed-side joint may be configured to have tubular shape.

The rotary-side joint may be rotatable in the circumferential direction. The fixed-side joint may be configured to be capable of reciprocating in the axial direction of approaching and separating from the rotary-side joint. The end face of one end of the fixed-side joint may face the end face of one end of the rotary-side joint. The fixed-side joint may have the second hole in the axial direction.

The attachment may be used by being fixed to another member. The attachment may have the third hole. The liquid may flow through the third hole. Since the other end of the fixed-side joint is inserted into the third hole, the third hole and the second hole of the fixed-side joint may communicate with each other.

A DLC film may be provided on the outer peripheral surface of the fixed-side joint. An elastic member may be interposed liquid-tight between the inner peripheral surface of the third hole of the attachment and the DLC film. The elastic member may slide relatively to the DLC film when the fixed-side joint moves in the axial direction. Hereinafter, the relative sliding of the elastic member against the DLC film is simply referred to as the sliding of the elastic member.

The DLC film may be provided in the contact area. The contact area may be in the range on the outer peripheral surface of the fixed-side joint where the elastic member contacts. Due to the low friction of the DLC film against the elastic member, the sliding of the elastic member can be smooth. Therefore, the movement of the fixed-side joint in the direction of approaching and separating from the rotary-side joint can be smooth.

Since the DLC film may be provided on the outer peripheral surface of the fixed-side joint using a well-known DLC coating technique, it is not necessary to form supply holes in the attachment for supplying grease. Therefore, the structure of the rotary joint device is simplified.

As a result, smooth reciprocating movement of the fixed-side joint and simplification of the structure can be achieved simultaneously.

The rotary-side joint may have the first hole in the axial direction through which fluid flows. When the fixed-side joint is in contact with the rotary-side joint, the second hole of the fixed-side joint may communicate with the first hole of the rotary-side joint. The liquid may flow through the third hole of the attachment, the second hole of the fixed-side joint, and the first hole of the rotary-side joint in this sequence.

Since the frictional force generated between the DLC film and the elastic member is small, the rotary joint device can be designed so that the force with which the elastic member contacts the DLC film is large. Therefore, liquid leakage between the inner peripheral surface of the third hole of the attachment and the outer peripheral surface of the fixed-side joint can be reliably prevented.

In the rotary joint device according to the present disclosure, the DLC film may be provided in the contact area and a non-contact area on the outer peripheral surface where the elastic member does not contact, and the non-contact area may be located on the end face side of the other end of the fixed-side joint relative to the contact area.

In the rotary joint device according to the present disclosure, the DLC film may be provided in the contact area and the non-contact area. The non-contact area may be a region on the outer peripheral surface of the fixed-side joint where the elastic member does not contact and is located on the end face side of the other end relative to the contact area.

A part of the liquid flowing through the third hole of the attachment may infiltrate between the DLC film provided in the non-contact area and the inner peripheral surface of the third hole. If foreign matter is mixed in the liquid, the foreign matter may infiltrate between the inner peripheral surface of the third hole of the attachment and the DLC film. However, due to the low friction of the DLC film against the foreign matter, the foreign matter will not hinder the movement of the fixed-side joint in the axial direction.

The DLC film may not necessarily be provided in the range on the outer peripheral surface of the fixed-side joint from the lower end of the contact area to the lower end of the fixed-side joint. This is because liquid will not infiltrate (and hence foreign matter mixed in the liquid will not infiltrate) between the inner peripheral surface of the third hole provided in the attachment and the DLC film if the DLC film is provided in this range.

In the rotary joint device according to the present disclosure, the elastic member may be an O-ring made of fluororubber.

Since the friction coefficient between the O-ring made of fluororubber and the DLC film is sufficiently small, the sliding of the elastic member may become even smoother.

A motor according to the present disclosure includes a rotary shaft rotatable in the circumferential direction and having a tubular shape and a through hole through which liquid is to flow in the axial direction, wherein the rotary shaft is connected with the rotary-side joint of the rotary joint device according to the present disclosure at another end of the rotary-side joint which is opposite to the one end of the rotary-side joint to integrally rotate with the rotary-side joint while the through hole and the first hole of the rotary-side joint communicate with each other.

In the motor according to the present disclosure, the rotary-side joint of the rotary joint device is connected to the rotary shaft. Therefore, smooth reciprocating movement of the fixed-side joint and simplification of the structure can be achieved simultaneously.

The rotary shaft may have tubular shape and configured to be rotatable in the circumferential direction. The rotary shaft may have a through hole in the axial direction through which fluid flows. The rotary shaft may be connected at the other end of the rotary-side joint such that the through hole of the rotary shaft and the first hole of the rotary-side joint may communicate with each other, and the rotary shaft may rotate integrally with the rotary-side joint.

A machine tool according to the present disclosure is a machine tool for processing a workpiece while discharging coolant from a nozzle using a tool provided with the nozzle, the machine tool including: the rotary joint device according to the disclosure; a fixed member to which the attachment of the rotary joint device is fixed; and a motor including a rotary shaft rotatable in the circumferential direction and having a tubular shape and a fourth hole through which liquid is to flow in an axial direction, wherein the rotary shaft is connected with the rotary-side joint of the rotary joint device at another end of the rotary-side joint which is opposite to the one end of the rotary-side joint to integrally rotate with the rotary-side joint while the through hole and the first hole of the rotary-side joint communicate with each other, wherein rotation of the rotary shaft is to be transmitted to the tool to rotate the tool, wherein the liquid is to flow through the third hole, the second hole, the first hole, and the fourth hole in this sequence to be ejected through the nozzle of the tool, wherein the DLC film being provided in the contact area where the elastic member contacts on the outer peripheral surface.

The attachment of the rotary joint device according to the present disclosure is fixed to the fixed member provided by the machine tool, and the rotary-side joint of the rotary joint device according to the present disclosure is connected to the rotary shaft of the motor provided by the machine tool. Therefore, smooth reciprocating movement of the fixed-side joint and simplification of the structure can be achieved simultaneously.

The rotary shaft may be configured to have a tubular shape and to be rotatable in the circumferential direction. The rotary shaft may have a fourth hole in the axial direction through which fluid flows. The rotary shaft may be connected to the other end of the rotary-side joint such that the fourth hole of the rotary shaft and the first hole of the rotary-side joint may communicate with each other, and the rotary shaft rotates integrally with the rotary-side joint. The rotation of the rotary shaft is transmitted to the tool, resulting in the rotation of the tool. The tool processes the workpiece. The tool has a nozzle. When the fixed-side joint is in contact with the rotary-side joint, the second hole of the fixed-side joint communicates with the first hole of the rotary-side joint. The liquid flows through the attachment's third hole, the fixed-side joint's second hole, the rotary-side joint's first hole, and the rotary shaft's fourth hole in this order and is ejected outward through the nozzle of the tool. The machine tool can process the workpiece while discharging coolant from the nozzle of the tool.

According to the rotary joint device, motor, and machine tool of the present disclosure, smooth reciprocating movement of the fixed-side joint and simplification of the structure can be achieved simultaneously.

### BRIEF DESCRIPTION OF DRAWINGS

FIG. 1 is a perspective view of a machine tool according to an embodiment.

FIG. 2 is a schematic cross-sectional view of a main part of the spindle head.

FIG. 3 is an enlarged schematic cross-sectional view of a main part of the spindle head.

FIG. 4 is a cross-sectional view of the rotary joint device.

### DESCRIPTION

Hereinafter, an embodiment of the present disclosure will be described. In the following description, the vertical (up-down), front-rear, and left-right directions indicated by the arrows in the drawings are used. As described later, in this embodiment, the upper side is the coolant (liquid) inflow side, and the lower side is the coolant outflow side.

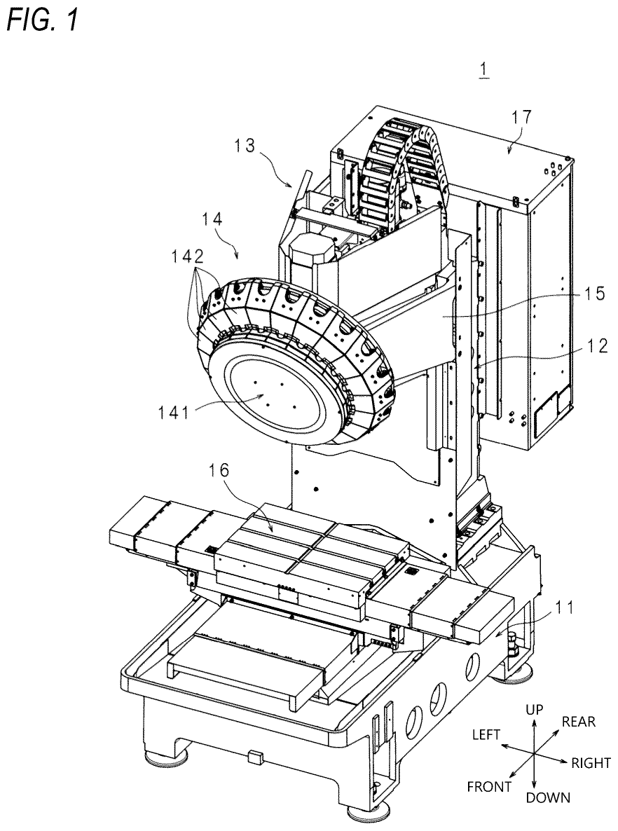

FIG. 1 is a perspective view of a machine tool according to an embodiment. In the following, the left-right direction, the front-rear direction, and the vertical direction of the machine tool 1 are the X-axis direction, the Y-axis direction, and the Z-axis direction, respectively. The machine tool 1 includes a base 11, a column 12, and a spindle head 13. The base 11 is a substantially rectangular parallelepiped iron pedestal installed on the floor. The column 12 is provided at the upper rear part of the base 11. The spindle head 13 is provided on the front face of the column 12 so as to be movable in the vertical direction. The column 12 includes a Z-axis motor for moving the spindle head 13 in the Z direction.

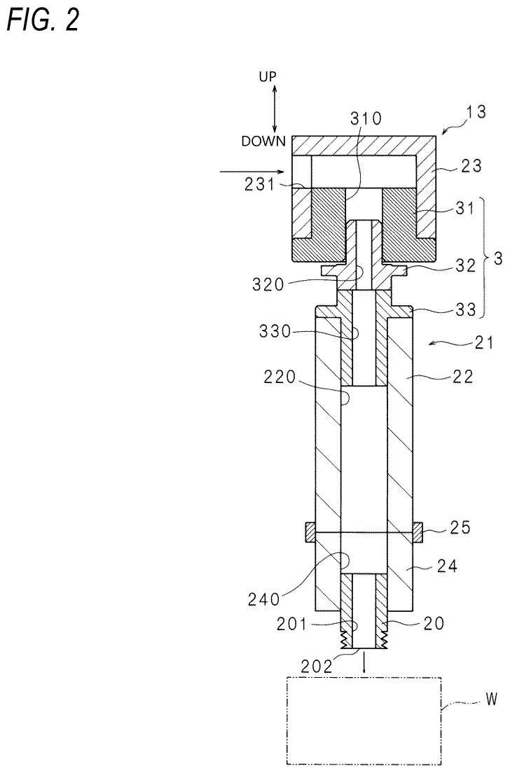

FIG. 2 is a schematic cross-sectional view of a main part of the spindle head 13. The spindle head 13 includes a motor 21. The motor 21 includes a rotary shaft 22, a rotor and a stator.

The rotary shaft 22 is cylindrical. The rotary shaft 22 is rotatable in the circumferential direction. The axial direction of the rotary shaft 22 is vertical. Since the rotary shaft 22 is tubular, it has a coaxial through hole in the axial direction. This through hole is the fourth hole 220 (flow passage). By supplying power to the motor 21 from the power supply in the control box 17, the rotary shaft 22 rotates in the circumferential direction.

The spindle head 13 further includes a fixed member 23 and a spindle 24. The fixed member 23, for example, is a bottomed cylindrical shape. The bottomed cylindrical fixed member 23 is arranged coaxially with the rotary shaft 22. The fixed member 23 is located above the motor 21, with the opening of the fixed member 23 facing downward. The fixed member 23 includes a supply port 231. The supply port 231, for example, is located on the peripheral wall of the fixed member 23.

The spindle 24 is located below the motor 21 and is at the lower part of the spindle head 13. The axial direction of the spindle 24 is vertical. The spindle 24 has a coaxial through hole 240. The upper end of the spindle 24 is connected coaxially and liquid-tight to the lower end of the rotary shaft 22 of the motor 21. For example, a coupling 25 connects the rotary shaft 22 and the spindle 24 to each other. By connecting the rotary shaft 22 and the spindle 24, the fourth hole 220 of the rotary shaft 22 and the through hole 240 of the spindle 24 communicate with each other, and the spindle 24 rotates in the circumferential direction along with the rotation of the rotary shaft 22.

In the drawing, 20 is a tool, which, for example, is an end mill used to cut the workpiece W. The tool 20 is columnar. The tool 20 has a flow path 201. The flow path 201 extends from one end of the tool 20 to the other end. The axial direction of the tool 20 is vertical. The lower end of the spindle 24 holds the upper end of the tool 20 detachably and liquid-tight. By the spindle 24 holding the tool 20, the through hole 240 of the spindle 24 communicates with the flow path 201 of the tool 20, and the tool 20 rotates in the circumferential direction along with the rotation of the spindle 24. The tool 20 has at least one nozzle 202. The nozzle 202 is located at the lower end of the tool 20 and communicates with the flow path 201.

As shown in FIG. 1, the machine tool 1 includes a tool changer 14, frames 15, a table 16, and a control box 17.

The tool changer 14 includes a disc-shaped magazine 141. A pair of left and right frames 15 holds the magazine 141 on the front side of the column 12 so that it does not interfere with the spindle head 13. The magazine 141 has multiple grip arms 142 arranged radially on the periphery. The grip arms 142 detachably hold the tool 20 through a tool holder. The tool changer 14 rotates the magazine 141 to position a predetermined tool 20 at the tool change position. The tool changer 14 replaces the tool 20 mounted on the spindle 24 with the tool 20 at the tool change position. The tool change position is the lowest position of the magazine 141.

The table 16 is located in front of the column 12 and below the magazine 141 at the upper part of the base 11. The user fixes the workpiece W to the table 16. The base 11 supports the table 16 so that it can move in the X-axis direction and the Y-axis direction, respectively. The table 16 is moved in the X-axis direction and Y-axis direction by an X-axis motor and a Y-axis motor which are provided in the machine tool 1.

The base 11 supports the control box 17 at the rear side of the column 12. A controller provided in the control box 17 controls the operation of the machine tool 1.

The table 16 moves forward, backward, left, and right to adjust the front-rear and left-right position of the tool 20 held by the spindle 24. The spindle head 13 moves up and down to adjust the vertical position of the tool 20 held by the spindle 24.

The machine tool 1 processes the workpiece W using the rotating tool 20. The tool 20 cuts the workpiece W by contacting it while rotating. During the processing of the workpiece W, coolant is supplied from a coolant supply device to the internal space of the fixed member 23 through the supply port 231, which increases the lubrication between the tool 20 and the workpiece W, and efficiently discharges chips.

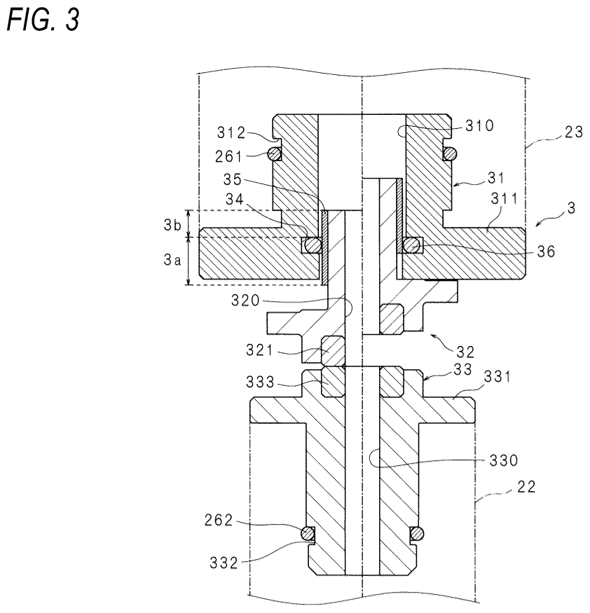

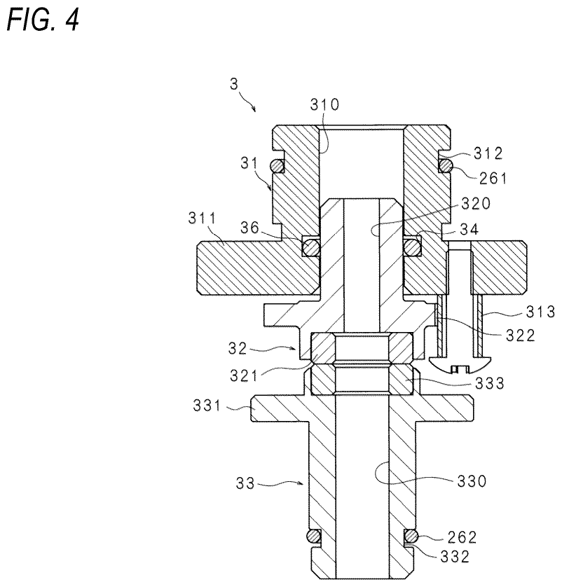

As shown in FIG. 2, the machine tool 1 further includes a rotary joint device 3. FIG. 3 is an enlarged schematic cross-sectional view of a main part of the spindle head 13, mainly showing the rotary joint device 3. FIG. 4 is a cross-sectional view of the rotary joint device 3. As shown in FIGS. 2-4, the rotary joint device 3 includes an attachment 31, a fixed-side joint 32, and a rotary-side joint 33.

The attachment 31 is tubular. Since the attachment 31 is tubular, it has a coaxial through hole in the axial direction. This through hole is the third hole 310. The attachment 31 has a flange 311 on the outer peripheral surface of one end. The attachment 31 is fixed to the fixed member 23.

For example, the attachment 31 is oriented vertically with a flange 311 at the lower end. The attachment 31 is inserted liquid-tight from below into the fixed member 23 through an opening in the fixed member 23. The flange 311 of the attachment 31 contacts the lower end face of the fixed member 23. By being inserted into the fixed member 23, the third hole 310 of the attachment 31 communicates with the internal space of the fixed member 23 through the supply port 231. The attachment 31 is located below the supply port 231 of the fixed member 23 and does not block the supply port 231.

As shown in FIGS. 3 and 4, the attachment 31 has a groove 312 on its outer peripheral surface. The groove 312 runs continuously in the circumferential direction of the attachment 31. An O-ring 261 is housed in the groove 312. As shown in FIG. 3, the O-ring 261 is interposed over the entire circumference between the outer peripheral surface of the attachment 31 and the inner peripheral surface of the fixed member 23. Therefore, liquid leakage between the attachment 31 and the fixed member 23 can be prevented.

As shown in FIGS. 2-4, both the fixed-side joint 32 and the rotary-side joint 33 are tubular. The inner diameter and outer diameter of the fixed-side joint 32 and the inner diameter and outer diameter of the rotary-side joint 33 are approximately the same. Both the fixed-side joint 32 and the rotary-side joint 33 are made of, for example, iron-based metals such as stainless steel or chrome-molybdenum steel, or aluminum-based metals. The axial direction of both the fixed-side joint 32 and the rotary-side joint 33 is vertical. The fixed-side joint 32 and the rotary-side joint 33 are arranged coaxially in this order from the top. The fixed-side joint 32 can reciprocate vertically relative to the attachment 31 but does not rotate. The rotary-side joint 33 can rotate in the circumferential direction but does not move vertically relative to the attachment 31. Hereinafter, the relative vertical movement of the fixed-side joint 32 with respect to the attachment 31 is simply referred to as vertical movement.

Since the rotary-side joint 33 is tubular, it has a coaxial through hole in the axial direction. This through hole is the first hole 330. The rotary-side joint 33 is connected coaxially and liquid-tight to the upper end of the rotary shaft 22 of the motor 21. By connecting the rotary shaft 22 and the rotary-side joint 33, the fourth hole 220 of the rotary shaft 22 and the first hole 330 of the rotary-side joint 33 communicate with each other, and the rotary-side joint 33 rotates in the circumferential direction along with the rotation of the rotary shaft 22.

For example, the rotary-side joint 33 is inserted liquid-tight into the rotary shaft 22 from above through an opening at the upper end side of the rotary shaft 22 so that the upper end of the rotary-side joint 33 protrudes upward from the rotary shaft 22. As shown in FIGS. 3 and 4, the rotary-side joint 33 has a flange 331 on its outer peripheral surface. The flange 331 contacts the upper end face of the rotary shaft 22 from above. By tightening the rotary-side joint 33 to the rotary shaft 22 with a screw, the rotary-side joint 33 can rotate along with the rotary shaft 22.

As shown in FIGS. 3 and 4, the rotary-side joint 33 has a groove 332 on its outer peripheral surface. The groove 332 runs continuously in the circumferential direction of the rotary-side joint 33. An O-ring 262 is housed in the groove 332. As shown in FIG. 3, the O-ring 262 is interposed over the entire circumference between the outer peripheral surface of the rotary-side joint 33 and the inner peripheral surface of the rotary shaft 22. Therefore, liquid leakage between the rotary-side joint 33 and the rotary shaft 22 can be prevented.

Since the fixed-side joint 32 is tubular, it has a coaxial through hole in the axial direction. This through hole is the second hole 320. As shown in FIGS. 2-4, at least the upper end of the fixed-side joint 32 is inserted coaxially into the third hole 310 of the attachment 31 from below so that the fixed-side joint 32 becomes coaxial with the attachment 31. The lower surface of the fixed-side joint 32 faces the upper surface of the rotary-side joint 33.

As shown in FIG. 3, a DLC film 35 is provided on the outer peripheral surface of the upper end of the fixed-side joint 32. The range where the DLC film 35 is provided will be described later. The DLC film 35 is a diamond-like carbon film with a thickness of several microns, which is very thin compared to the thickness of the peripheral wall of the fixed-side joint 32. However, in FIG. 3, the DLC film 35 is shown thicker for clarity. To obtain low friction characteristics with the elastic member 36, the hydrogen content of the DLC film 35 is preferably 40-70 atomic percent.

As shown in FIGS. 3 and 4, the third hole 310 of the attachment 31 has a groove 34 on the inner peripheral surface. The groove 34 runs continuously in the circumferential direction of the attachment 31. An elastic member 36 is housed in the groove 34.

The elastic member 36 is an O-ring made of fluororubber (preferably vinylidene fluoride-based rubber (FKM)). The elastic member 36 has a circular cross-section. The elastic member 36 is interposed liquid-tight over the entire circumference between the inner peripheral surface of the third hole 310 of the attachment 31 and the DLC film 35 so that the DLC film 35 can slide vertically relative to the elastic member 36.

The coolant that has flowed into the internal space of the fixed member 23 through the supply port 231 shown in FIG. 2 flows into the third hole 310 of the attachment 31 from the internal space of the fixed member 23. The fixed-side joint 32 moves downward due to the hydraulic pressure of the coolant that has flowed into the third hole 310 of the attachment 31. When the fixed-side joint 32, which is separated from the rotary-side joint 33, moves downward, the lower surface of the fixed-side joint 32 approaches the upper surface of the rotary-side joint 33. By the lower surface of the fixed-side joint 32 coming into contact with the upper surface of the rotary-side joint 33 from above, the fixed-side joint 32 that has moved downward can be prevented from falling out of the attachment 31.

For example, the hydraulic pressure of the coolant supplied from the coolant supply device is 7 MPa, and the coolant presses the lower surface of the fixed-side joint 32 against the upper surface of the rotary-side joint 33. At this time, the lower surface of the fixed-side joint 32 and the upper surface of the rotary-side joint 33 are in close contact with each other, thus preventing liquid leakage between the lower surface of the fixed-side joint 32 and the upper surface of the rotary-side joint 33.

When the lower surface of the fixed-side joint 32 is in contact with the upper surface of the rotary-side joint 33, the second hole 320 of the fixed-side joint 32 communicates with the first hole 330 of the rotary-side joint 33. The coolant that has flowed into the third hole 310 of the attachment 31 flows in this order through the third hole 310 of the attachment 31, the second hole 320 of the fixed-side joint 32, the first hole 330 of the rotary-side joint 33, the fourth hole 220 of the rotary shaft 22 of the motor 21, and the through-hole 240 of the spindle 24. The coolant that has flowed through the through-hole 240 of the spindle 24 flows into the flow path 201 of the tool 20. The coolant that has flowed into the flow path 201 of the tool 20 is ejected outward through the nozzle 202. When machining the workpiece W, the coolant reduces the friction between the tool 20 and the workpiece W and washes away the chips generated during the machining of the workpiece W.

In a case where the supply of coolant stops while the motor 21 is rotating, the wind pressure generated by the rotation of the rotary-side joint 33 pushes the fixed-side joint 32 upwards, thus moving the fixed-side joint 32 upwards. Note that the rotary joint device 3 may include a biasing member that biases the fixed-side joint 32 upwards. The force with which the biasing member biases the fixed-side joint 32 upwards is smaller than the force with which the coolant pushes the fixed-side joint 32 downwards.

In a case where the fixed-side joint 32, which is in contact with the rotary-side joint 33, moves upwards, the lower surface of the fixed-side joint 32 separates from the upper surface of the rotary-side joint 33, as shown in FIG. 3. The separation distance between the lower surface of the fixed-side joint 32 and the upper surface of the rotary-side joint 33 is, for example, several millimeters, but it is exaggerated in FIG. 3 for clarity.

As shown in FIG. 4, the fixed-side joint 32 has a guide receiving section 322. The guide receiving section 322 is, for example, a notch provided at the outer edge of a flange portion of the fixed-side joint 32. The guide receiving section 322 is penetrated by a cylindrical guide 313. The guide 313 extends vertically and is screwed to the attachment 31 so as to hang down from the lower surface of the flange 311 of the attachment 31.

By the inner surface of the guide receiving section 322 contacting the outer peripheral surface of the guide 313, the guide 313 also functions as a stopper to prevent the fixed-side joint 32 from rotating in the circumferential direction. Therefore, even if the lower surface of the fixed-side joint 32 is in contact with the upper surface of the rotary-side joint 33, the rotation of the fixed-side joint 32 can be prevented from rotating along with the rotation of the rotary-side joint 33.

While the rotary-side joint 33 is rotating, the upper surface of the rotary-side joint 33 slides circumferentially against the lower surface of the fixed-side joint 32.

To reduce friction and wear caused by sliding, sliding auxiliary members 321 and 333 may be provided on the peripheral edges of the openings on the lower surface of the fixed-side joint 32 and the upper surface of the rotary-side joint 33, respectively.

The sliding auxiliary members 321 and 333 are respectively annular and flat in the axial direction and are coaxial with the fixed-side joint 32 and the rotary-side joint 33. Contact between the lower surface of the fixed-side joint 32 and the upper surface of the rotary-side joint 33 means contact between the sliding auxiliary member 321 and the sliding auxiliary member 333. The sliding auxiliary members 321 and 333 are wear-resistant and made of, for example, silicon carbide.

Due to the reciprocating vertical movement of the fixed-side joint 32, the elastic member 36 slides vertically relative to the DLC film 35. Hereinafter, the relative vertical sliding of the elastic member 36 against the DLC film 35 will simply be referred to as the sliding of the elastic member 36. Now, the range where the DLC film 35 is provided will be described.

As shown in FIG. 3, the DLC film 35 is provided in the contact area 3a and the non-contact area 3b.

The contact area 3a is a range on the outer peripheral surface of the fixed-side joint 32 where the elastic member 36 contacts. Due to the low friction of the DLC film 35 against the elastic member 36, the sliding of the elastic member 36 can be smooth. Therefore, the movement of the fixed-side joint 32 in the vertical direction relative to the rotary-side joint 33 can be smooth. The contact area 3a is located in the middle of the axial direction of the fixed-side joint 32.

The non-contact area 3b is a range on the outer peripheral surface of the fixed-side joint 32 where the elastic member 36 does not contact. The non-contact area 3b is continuous with the contact area 3a and extends from the upper end of the contact area 3a to the upper end of the fixed-side joint 32. Note that the non-contact area 3b only needs to be located above the contact area 3a, and it does not need to extend to the upper end of the fixed-side joint 32. As shown in FIG. 4, when the upper edge of the fixed-side joint 32 is chamfered, the DLC film 35 may or may not be provided on the chamfered portion of the fixed-side joint 32.

There is a gap between the inner peripheral surface of the third hole 310 of the attachment 31 and the DLC film 35 for the smooth vertical movement of the fixed-side joint 32. This gap is exaggerated in FIG. 3 for clarity. A part of the coolant that has flowed into the third hole 310 of the attachment 31 infiltrates the gap between the inner peripheral surface of the non-contact area 3b of the third hole 310 of the attachment 31 and the DLC film 35. Although the gap between the inner peripheral surface of the third hole 310 of the attachment 31 and the DLC film 35 is narrow, if minute foreign matter is mixed in the coolant, the foreign matter may infiltrate the gap between the inner peripheral surface of the third hole 310 of the attachment 31 and the DLC film 35. However, due to the low friction of the DLC film 35 against the foreign matter, there the foreign matter will not hinder the movement of the fixed-side joint 32 in the vertical direction.

Since the DLC film 35 can be provided on the outer peripheral surface of the fixed-side joint 32 using a well-known DLC coating technique, there is no need to form supply holes in the attachment 31 for supplying grease between the outer peripheral surface of the fixed-side joint 32 and the elastic member 36. Therefore, the structure of the rotary joint device 3 is simplified.

As a result, smooth reciprocating movement of the fixed-side joint 32 and simplification of the structure can be achieved simultaneously.

Moreover, since the DLC film 35 is highly resistant to coolant and wear, it is maintenance-free.

Since the frictional force generated between the DLC film 35 and the elastic member 36 is small, the rotary joint device 3 can be designed so that the force with which the elastic member 36 contacts the DLC film 35 is large. Since the elastic member 36 is an O-ring, the compression rate of the elastic member 36 can be increased so that the force with which the elastic member 36 contacts the DLC film 35 is large. Therefore, liquid leakage between the inner peripheral surface of the third hole 310 of the attachment 31 and the outer peripheral surface of the fixed-side joint 32 can be reliably prevented.

The compression rate of the elastic member 36 is preferably 10-30%. If the cross-sectional diameter of the elastic member 36 is 1.9 mm, the inner diameter of the third hole 310 of the attachment 31 is 12 mm, and the outer diameter of the fixed-side joint 32 is 9 mm, the compression rate is about 21% (={1.9−(12−9)/2}+1.9×100).

The DLC film 35 may not necessarily be provided in the range on the outer peripheral surface of the fixed-side joint 32 from the lower end of the contact area 3a to the lower end of the fixed-side joint 32. This is because the coolant will not infiltrate (and hence foreign matter mixed in the coolant will not infiltrate) the gap between the inner peripheral surface of the third hole 310 of the attachment 31 and the DLC film 35 if the DLC film is provided in this range. At least the surface roughness (arithmetic average roughness Ra) of the fixed-side joint 32's outer peripheral surface in the contact area 3a and the non-contact area 3b is desirably 0.2 or less. If the arithmetic average roughness exceeds 0.2, the low friction of the DLC film 35 may be insufficient due to the surface roughness of the contact area 3a and the non-contact area 3b.

Herein, it is considered to provide a diamond film on the outer peripheral surface of the fixed-side joint 32 instead of the DLC film 35. The diamond film is more wear-resistant than the DLC film 35.

However, generally, the temperature during the deposition of a CVD diamond film using a hot filament method, which can also form films on the external surface of the joint, is higher than the temperature during the DLC film 35 deposition. A fixed-side joint 32 exposed to the high temperature (about 600-700° C.) during diamond film deposition is prone to distortion. On the other hand, the fixed-side joint 32 is less prone to distortion even if exposed to the low temperature (200° C. or lower) during DLC film 35 deposition. Furthermore, thickness control during diamond film deposition is difficult, but thickness control during DLC film 35 deposition is easy. Therefore, adopting the DLC film 35 contributes to the improvement of the rotary joint device 3's accuracy. Additionally, the diamond film is more expensive than the DLC film 35. Therefore, adopting the DLC film 35 contributes to the reduction of manufacturing costs for the rotary joint device 3.

Moreover, if the foreign matter mixed in the coolant will not infiltrate the gap between the inner peripheral surface of the third hole 310 of the attachment 31 and the outer peripheral surface of the fixed-side joint 32 and not hinders the vertical movement of the fixed-side joint 32, it is unnecessary to provide the DLC film 35 in the non-contact area 3b.

The elastic member 36 is not limited to an O-ring made of fluororubber. The elastic member 36 may be made of any material that has a low coefficient of friction with the DLC film 35, is not easily eroded by the coolant, and can function as a packing.

The rotary joint device 3 is not limited to the configuration provided in the machine tool 1. The attachment 31 is not limited to being fixed to the fixed member 23. The rotary-side joint 33 is not limited to being connected to the rotary shaft 22 of the motor 21. The direction in which the fixed-side joint 32 and the rotary-side joint 33 face each other is not limited to the vertical direction. The reciprocating movement direction of the fixed-side joint 32 is not limited to the vertical direction.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A rotary joint device comprising:
a rotary-side joint having a tubular shape and a first hole through which liquid is to flow in an axial direction, the rotary-side joint being rotatable in a circumferential direction;
a fixed-side joint having a tubular shape and an end face at one end facing an end face at one end of the rotary-side joint, the fixed-side joint being configured to reciprocate in the axial direction of approaching and separating from the rotary-side joint, the fixed-side joint further having a second hole in the axial direction that communicates with the first hole of the rotary-side joint in a state where the fixed-side joint is in contact with the rotary-side joint;
an attachment having an inner peripheral surface, the attachment being fixable to another member, the inner peripheral surface defining a third hole through which the liquid is to flow and into which the other end of the fixed-side joint is inserted;
a DLC (diamond-like carbon) film provided on an outer peripheral surface of the fixed-side joint; and
an elastic member interposed liquid-tight between the inner peripheral surface of the attachment and the DLC film, the elastic member being slidable with respect to the DLC film when the fixed-side joint moves in the axial direction with respect to the rotary-side joint,
wherein the DLC film is provided in a contact area where the elastic member contacts on the outer peripheral surface.

2. The rotary joint device according to claim 1,
wherein the DLC film is provided in the contact area and a non-contact area on the outer peripheral surface where the elastic member does not contact, and
wherein the non-contact area is located on the end face side of the other end of the fixed-side joint relative to the contact area.

3. The rotary joint device according to claim 1,
wherein the elastic member is an O-ring made of fluororubber.

4. A motor comprising:
a rotary shaft rotatable in the circumferential direction and having a tubular shape and a through hole through which liquid flows in an axial direction,
wherein the rotary shaft is connected with the rotary-side joint of the rotary joint device according to claim 1 at another end of the rotary-side joint which is opposite to the one end of the rotary-side joint to integrally rotate with the rotary-side joint while the through hole and the first hole of the rotary-side joint communicate with each other.

5. A machine tool for processing a workpiece while discharging coolant from a nozzle using a tool provided with the nozzle, the machine tool comprising:
the rotary joint device according to claim 1;
a fixed member to which the attachment of the rotary joint device is fixed; and
a motor including a rotary shaft rotatable in the circumferential direction and having a tubular shape and a fourth hole through which liquid is to flow in an axial direction,
wherein the rotary shaft is connected with the rotary-side joint of the rotary joint device at another end of the rotary-side joint which is opposite to the one end of the rotary-side joint to integrally rotate with the rotary-side joint while the through hole and the first hole of the rotary-side joint communicate with each other,
wherein rotation of the rotary shaft is to be transmitted to the tool to rotate the tool,
wherein the liquid is to flow through the third hole, the second hole, the first hole, and the fourth hole in this sequence to be ejected through the nozzle of the tool,
wherein the DLC film being provided in the contact area where the elastic member contacts on the outer peripheral surface.
